(19) United States
(12) Patent Application Publication
(10) Pub. No.: US 2022/0327950 A1
(43) Pub. Date: Oct. 13, 2022

(54) SYSTEM AND METHOD FOR PROVIDING INTERACTIVE VIRTUAL TRAINING TO MULTIPLE MEDICAL PERSONNEL IN REAL-TIME

(71) Applicant: Siemens Healthcare GmbH, Erlangen (DE)

(72) Inventors: Hardik Singh, Bangalore (IN); Manivannan Sundarapandian, Bangalore (IN)

(21) Appl. No.: 17/715,422

(22) Filed: Apr. 7, 2022

(30) Foreign Application Priority Data
Apr. 13, 2021 (DE) 10 2021 109 241.8

(51) Int. Cl. G09B 9/00; G06F 21/44; G06F 9/451

(52) U.S. Cl. CPC G09B 9/00; G06F 21/44; G06F 9/451; G09B 23/286

(57) ABSTRACT

The present disclosure relates to providing interactive virtual training to multiple medical personnel in real-time. A processing unit receives simulation data pertaining to a medical device, and a simulation model of the medical device is hosted on a server. The simulation model is generated from the received simulation data. The simulation model is securely provided on at least one first graphical user interface and at least one second graphical user interface. The at least one first graphical user interface corresponds to a trainer and the at least one second graphical user interface corresponds to a trainee.

### RELATED APPLICATION

This application claims the benefit of German Application 10 2021 109 241.8, filed on Apr. 13, 2021, which is hereby incorporated by reference in its entirety.

### FIELD OF TECHNOLOGY

The present disclosure relates to virtual training systems and more particularly relates to a system and a method for providing interactive virtual training to multiple medical personnel in real-time.

### BACKGROUND

Simulation-based training is a well-recognized component in maintaining and improving skills. Consequently, simulation-based training is critically important for a number of medical professionals such as doctors, nurses and medical surgeons, radiologists among others. Such skills require hand-eye coordination, spatial awareness, and integration of multi-sensory input, such as tactile and visual. Henceforth, it is essential to train the professionals in a manner that hands-on training is imparted.

Operation of medical devices, such as in x-ray imaging, in computed x-ray tomography (also called computed tomography and abbreviated as CT), in magnetic resonance tomography (abbreviated as MR or MRT), in ultrasound imaging, in magnetic resonance imaging (MRI), and in functional MRI, are performed by highly skilled medical professionals who require rigorous training on medical devices itself or simulators. Such skills are today primarily obtained through hands-on training in medical school, at training programs, and at short courses. These training sessions are an expensive proposition because a number of imaging systems, simulators, and qualified trainers are needed, which detract from their normal diagnostic and revenue-generating activities. Furthermore, providing training to a large number of professionals is also a challenge due to requirement of physical presence of trainees at training sessions. Additionally, providing in-person training to multiple professionals is expensive which involves infrastructure costs, travel costs, lodging costs etc. Moreover, multiple sessions are to be organized to effectively provide training to large number of trainees making the process expensive and time consuming. In an attempt to solve the aforementioned problems associated with physical training, online trainings are being introduced lately. In an online training of medical simulators, both the trainers and the trainees have to engage with the system for a trainee to effectively comprehend complex training procedures of medical devices. However, in most of the online training sessions either the trainee is left on his own to comprehend the functioning of the simulator or is guided by a trainer through a screen-sharing session. Such training sessions are ineffective and do not provide interactive experience to the trainees.

### SUMMARY

In light of the above, there is a need for a method for providing interactive virtual training to multiple medical personnel in real-time, thereby allowing multiple medical personnel to access the simulator for an interactive training session in a in a cost-effective, less time-consuming, realistic, and consistent way.

A system and a method for providing interactive virtual training to multiple medical personnel in real-time is disclosed. The method includes receiving, by a processing unit (processor), simulation data pertaining to a medical device. The method includes hosting a simulation model of the medical device on a server. The simulation model is generated from the received simulation data. The method includes securely providing the simulation model on at least one first graphical user interface and at least one second graphical user interface, wherein the at least one first graphical user interface corresponds to a trainer and the at least one second graphical user interface corresponds to a trainee.

According to an embodiment, the server includes a first server and at least one second server hosted in private networks.

According to an embodiment, the simulation model includes a simulator and at least one control component, and wherein the simulator is hosted on the first server and the at least one control component is hosted on the at least one second server.

According to an embodiment, the method of providing the simulation model on the graphical user interface includes recording a change in the simulation model from a first state to a second state on the at least one first graphical user interface based on an input on the first graphical user interface. The method includes outputting the change in the simulation model from the first state to the second state on the at least one second graphical user interface in real-time.

In an embodiment, the method of providing the simulation model on the graphical user interface includes activating the at least one control component on the at least one second graphical user interface associated with the trainee based on a response from the trainer on the at least one first graphical user interface.

In an embodiment, the method of activating the at least one control component on the at least one second graphical user interface further includes providing viewing access to the at least one second graphical user interface. In an embodiment, the method of activating the at least one control component on the at least one second graphical user interface further includes providing control access to the at least one second graphical user interface.

In an embodiment, the method of providing viewing access to the at least one second graphical user interface includes recording a change in an operation of the control component from a first parameter to a second parameter based on an input on the first graphical user interface. The method includes outputting the change in the operation of the control component from the first parameter to the second parameter on the at least one second graphical user interface in real-time. The method includes recording a change in the simulation model based on the change in the operation of the control component. The method includes outputting the change in the simulation model on the at least one second graphical user interface in real-time.

In an embodiment, the method of providing control access to the at least one second graphical user interface includes recording a change in an operation of the control component from a first parameter to a second parameter based on an input on the at least one second graphical user interface. The method includes outputting the change in the operation of the control component from the first parameter to the second parameter on the at least one first graphical user interface and the at least one second graphical user interface in real-time. The method includes recording a change in the simulation model based on the change in the operation of the control component. The method includes outputting the change in the simulation model on the at least one first graphical user interface and at least one second graphical user interface in real-time.

In an embodiment, the method of securely providing the simulation model on the at least one first graphical user interface and the at least one second graphical user interface further includes establishing a secure connection between the first server, the second server and user devices associated with the first graphical user interface and the at least one second graphical user interface via a third server.

In an embodiment, the method further includes validating an authenticity of the user devices associated with the first graphical user interface and the at least one second graphical user interface using a database including valid user devices.

The object is also achieved by an apparatus for providing interactive virtual training to multiple medical personnel in real-time. The apparatus includes at least one processing unit (processor), a database including information pertaining to valid user devices, and a memory communicatively coupled to the one or more processing units, the memory including a simulator access module configured to perform the aforementioned method acts.

The object is also achieved by a system for providing interactive virtual training to multiple medical personnel in real-time. The system including a server for remotely hosting a simulation model, and a cloud computing platform including computer readable instructions, which when executed by a processing unit (processor) cause the processing unit to perform the aforementioned method acts.

The object is also achieved by a computer-program product having machine-readable instructions stored therein, which when executed by one or more processing units (processors), cause the processing units to perform a method as described above.

The object is also achieved by a non-transitory computer-readable storage medium including machine readable instructions which are readable and executable by a processing unit (processor), to execute the method a method as described above, when the computer readable instructions are executed by the processing unit.

The above-mentioned attributes, features, and advantages and the manner of achieving them, will become more apparent and understandable (clear) with the following description of embodiments of the invention in conjunction with the corresponding drawings. The illustrated embodiments are intended to illustrate, but not limit the invention.

### BRIEF DESCRIPTION OF THE DRAWINGS

The present invention is further described hereinafter with reference to illustrated embodiments shown in the accompanying drawings, in which:

FIG. 1 illustrates a system for providing interactive virtual training to multiple medical personnel in real-time, in accordance with one embodiment;

FIG. 2 illustrates an apparatus for providing interactive virtual training to multiple medical personnel in real-time, in accordance with one embodiment;

FIG. 3 illustrates a flowchart depicting acts of a method for providing interactive virtual training to multiple medical personnel in real-time, in accordance with one embodiment;

FIG. 4 illustrates a flow diagram depicting interaction between user devices and simulator, in accordance with an embodiment;

FIG. 5 illustrates a control flow diagram depicting exchange of control signals between one or more entities of the system of FIG. 1, in accordance with an embodiment;

FIG. 6 illustrates a control flow diagram depicting exchange of control signals between one or more entities of the system of FIG. 1, in accordance with another embodiment;

FIG. 7 illustrates a flowchart depicting acts of a method for providing viewing access to the at least one second graphical user interface, in accordance with an embodiment;

FIG. 8 illustrates a control flow diagram depicting exchange of control signals between one or more entities of the system for providing viewing access to the at least one second graphical user interface, in accordance with an embodiment;

FIG. 9 illustrates a flowchart depicting acts of a method for providing control access to the at least one second graphical user interface, in accordance with an embodiment of the present invention

FIG. 10 illustrates a control flow diagram depicting exchange of control signals between one or more entities for providing control access to the at least one second graphical user interface, in accordance with an embodiment.

### DETAILED DESCRIPTION

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

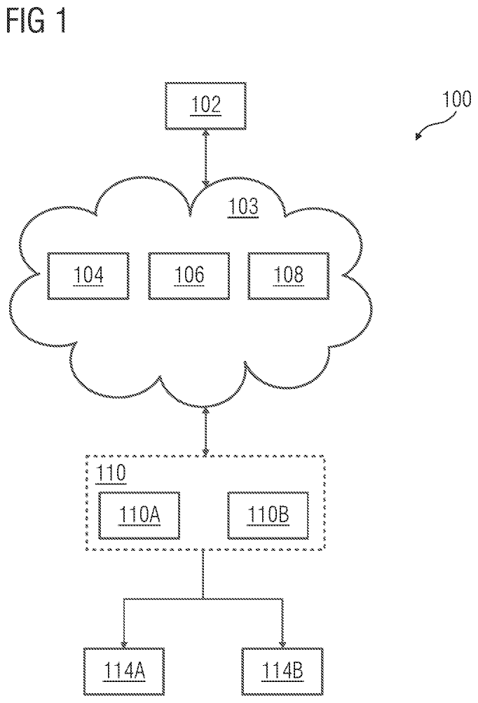

Disclosed embodiments provide systems and methods for providing interactive virtual training to multiple medical personnel in real-time. The term “virtual training” refers to training provided over a communication network (such as Internet) to multiple users or trainees in real-time simultaneously. Referring to FIG. 1, a system 100 for providing interactive virtual training to multiple medical personnel in real-time is described, in accordance with one embodiment. The term “interactive” as used herein refers to a feature of providing active training to the medical personnel in a manner that the trainees or the medical personnel are provided access to the simulator and control components for a hands-on experience and training. The changes made by the trainer or the trainee are reflected on the graphical user interfaces in real-time. By the “real-time” it is meant that one or more changes that may be input by the user (such as trainer or the trainee) are simultaneously reflected on the first graphical user interface and the second graphical user interface without time delay.

In an exemplary implementation, the system 100 is realized as a cloud computing system 100. The system 100 can be a cloud infrastructure capable of providing cloud-based services such as data storage services, data simulation services, data visualization services, etc. based on the data from one or more sources 102. The cloud computing system 100 can be part of public cloud or a private cloud 103. The cloud computing system 100 includes processing unit 104, memory 106 and a database 108. Further, the cloud infrastructure includes a cloud communication interface, a cloud computing hardware and an operating system (OS), and a cloud computing platform. The cloud communication interface enables communication between the processing unit 104, and user devices 114A and 114B. The cloud computing hardware and the OS may include one or more servers on which the OS is installed and includes one or more processing units, one or more storage devices for storing data, and other peripherals required for providing cloud computing functionality. The cloud computing platform implements functionalities such as data storage, data analytics, data visualization, data communication on the cloud hardware and OS via APIs and algorithms, and delivers the aforementioned cloud services using cloud based applications (e.g., computer-aided design application).

According to an embodiment, the server 110 includes a first server 110A and at least a second server 110B. Hereinafter, for the sake of simplicity and clarity, the terms “first server” 110A and the “second server” 110B may sometimes collectively be referred to as the “server” 110. Throughout the present disclosure, the term server 110 as used herein refers to a structure and/or module that include programmable and/or non-programmable components configured to store, process and/or share information. Optionally, the server 110 includes any arrangement of physical or virtual computational entities capable of enhancing information to perform various computational tasks. Furthermore, it should be appreciated that the server 110 may be both single hardware server and/or plurality of hardware servers operating in a parallel or distributed architecture. In an example, the server 110 may include components such as memory, a processor, a network adapter and the like, to store, process and/or share information with other computing components, such as user device/user equipment. Optionally, the server 110 is implemented as a computer program that provides various services (such as database service) to other devices, modules or apparatus. In an example, the server is a Virtual Network Computing (VNC) server. The VNC server is a graphical desktop-sharing system that uses Remote Frame Buffer protocol (RFB) to remotely control another computer. It transmits input events such as keyboard and mouse events from one computer to another, relaying the graphical-screen updates back in the other direction, over a network. The VNC server is a platform-independent server and there are clients and servers for many GUI-based operating systems such that multiple clients may connect to the VNC server at the same time.

In a preferred embodiment, the first server 110A is configured to host the simulation model of the simulator of the medical device. The second server 110B is configured to host the simulation model of the at least one control component of the medical device. It should be understood that a plurality of control components may be associated with medical device. In such a case, each of the control components is hosted on a different server. Beneficially, hosting the simulation model of the medical device and at least one control component on different servers ensures multiple user access during a training session. In an embodiment, the system 100 includes a third server configured for providing the simulator and the at least one control component on at least a first graphical user interface 114A and at least a second graphical user interface 114B. In an example, the third server is a guacamole server. The Guacamole server is a gateway to provide access to multiple user access over the Internet via a web browser. The Guacamole server is configured for sharing of simulators with multiple users at the same time. The Guacamole server converts the data stream received from the simulator hosted in a VNC server and converts it to Guacamole protocol which can be relayed over the internet (HTTPS). Guacamole creates an endpoint URL for every VNC server such that each unit of the simulator is represented with endpoints created by Guacamole. The Guacamole server enables the management of endpoints with the help of a backend component. When the trainees have only view access, actions performed by trainees are blocked at the Guacamole server. Furthermore, only when a control access is provided to the trainees, the Guacamole server allows the actions to pass to the simulator unit which is hosted in a protected zone in the VNC server. Advantageously, the Guacamole server secures the simulation model of the medical device and the control components of the medical devices from any malicious activity. Further, the Guacamole server also provides multiple users access to the same simulator in real-time. Herein, the first graphical user interface 114A corresponds to a trainer and the second graphical user interface 114B corresponds to a trainee. Further, the first graphical user interface is associated with a first user device (not shown) pertaining to the trainer. The second graphical user interface 114B is associated with a second user device (not shown) pertaining to the trainee.

The processing unit (processor) 104 is configured to receive simulation data pertaining to the medical device. The processing unit 104 is configured to host the simulation model of the medical device on the server 110. The processing unit 104 is configured to provide the simulation model on the at least one first graphical user interface 114A and the at least one second graphical user interface 114B, wherein the first graphical user interface 114A corresponds to a trainer and the second graphical user interface 114B corresponds to a trainee.

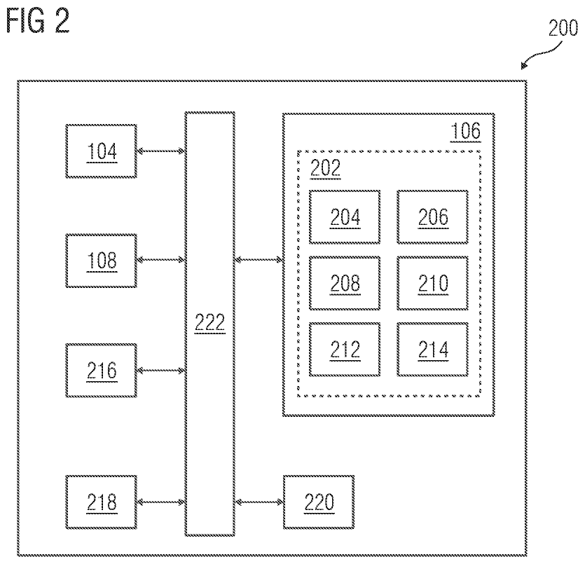

Referring to FIG. 2, illustrated is an apparatus 200 for providing interactive virtual training to multiple medical personnel in real-time, in accordance with one embodiment. The apparatus 200 includes a processing unit 104 for performing the method acts as aforementioned. The processing unit 104, as used herein, may refer to any type of computational circuit, including, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 104 may also include embedded controllers, such as generic or programmable logic devices or arrays, application specific integrated circuits, single-chip computers, and the like. In general, a processing unit 104 may include hardware elements and software elements. The processing unit 104 can be configured for multithreading, i.e. the processing unit 104 may host different calculation processes at the same time, executing them either in parallel or switching between active and passive calculation processes.

The apparatus 200 includes a memory 106. The memory 106 may include a volatile memory and a non-volatile memory. The memory 106 may be coupled for communication with the processing unit 104. The processing unit 104 may execute instructions and/or code stored in the memory 106. A variety of instructions may be stored in and accessed from the memory 106. The memory 106 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

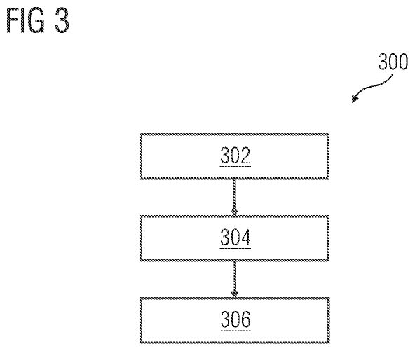

The memory 106 includes a simulator access module 202 configured to perform the method acts as described in greater detail in FIG. 3. Furthermore, the memory includes a retrieval module 204, a simulation model hosting module 206, a secure relay module 208, a simulation instance generation module 210, a control module 212, and a validation module 214 henceforth collectively referred as the simulator access module 202. The simulator access module 202 is stored in the form of machine-readable instructions on any of the abovementioned storage media and may be in communication to and executed by the one or more processing units 104. The following description explains functions of the modules when executed by the one or more processing units 104.

The retrieval module 204 is configured for obtaining simulation data of the medical device from a source 102. In one or more example, the source 102 may be a simulator for a medical device. The simulation data pertaining to the functioning of the simulator of the medical device and corresponding control components are received by the retrieval module.

The simulation model hosting module 206 is configured for hosting the simulation model of the medical device and corresponding control components on a server 110. The simulation model hosting module 206 is further configured for dividing the received simulation data into different modules such that the simulator for medical device is hosted on a first server and other control components are hosted on different second servers.

The secure relay module 208 is configured for converting data stream received from the simulation model hosted in the server 110 and converts it to a Guacamole protocol. The converted data stream can be securely relayed over a communication network in a secure manner.

The simulation instance generation module 210 is configured for providing an instance of the simulation model to one or more user devices simultaneously in real-time.

The control module 212 is configured for providing control access to one or more user devices. The control access is provided to one or more user devices by activating control components on the at least one second graphical user interface.

The validation module 214 is configured for validating an authenticity of the one or more user devices based on the database 108. The validation module 214 ensures that only authenticated user devices are provided access to the simulation model, thereby securing the simulation model from any exploitation by unauthorized users.

The storage unit 216 may be a non-transitory storage medium which stores the database 108. The database 108 may store credentials and information pertaining to various validated user devices. The apparatus 200 may further include an input unit (input) 218 and an output unit (output or display) 220. The input unit 218 may include input devices such as keypad, touch-sensitive display, camera (such as a camera receiving gesture-based inputs), etc., capable of receiving input signals such as inputs to the simulator for changing state of the simulator, requests for providing access, and the like. The output unit (display) 220 may be a user device with a graphical user interface (including both the first graphical user interface and the second graphical user interface) for displaying a simulation instance of the simulator, displaying a change in the state of the simulator based on the response from the input units, and so forth. The bus 222 acts as interconnection between the processing unit 104, the memory 106, the storage unit 216, the input unit 218, and the output unit 220.

Those of ordinary skilled in the art will appreciate that the hardware depicted in FIGS. 1 and 2 may vary for different implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter, network connectivity devices also may be used in addition or in place of the hardware depicted. The depicted example is provided for the purpose of explanation only and is not meant to imply architectural limitations with respect to the present invention.

A system in accordance with an embodiment includes an operating system employing a Graphical User Interface. The operating system permits multiple display windows to be presented in the Graphical User Interface simultaneously with each display window providing an interface to a different application or to a different instance of the same application. A cursor in the Graphical User Interface may be manipulated by a user through the pointing device. The position of the cursor may be changed and/or an event such as clicking a mouse button, generated to actuate a desired response.

One of various commercial operating systems, such as a version of Microsoft Windows™ may be employed if suitably modified. The operating system is modified or created in accordance with the present invention as described.

The present embodiments are not limited to a particular computer system platform, processing unit, operating system, or network. One or more aspects may be distributed among one or more computer systems, for example, servers configured to provide one or more services to one or more client computers, or to perform a complete task in a distributed system. For example, one or more aspects may be performed on a client-server system that includes elements distributed among one or more server systems that perform multiple functions according to various embodiments. These elements include, for example, executable, intermediate, or interpreted code, which communicate over a network using a communication protocol. The present embodiments are not limited to be executable on any particular system or group of systems and are not limited to any particular distributed architecture, network, or communication protocol.

Referring to FIG. 3, in conjunction with FIGS. 1 and 2, a flowchart depicting acts of a method 300 for providing interactive virtual training to multiple medical personnel in real-time is described, in accordance with one embodiment of the present invention. The method 300 includes acts 302 to 306 and may be implemented on the system 100.

At act 302, the simulation data pertaining to the medical device is received. The simulation data may be received from the source 102. Herein, the source 102 may be a simulator for simulating a medical device. In an example, the medical device may be an imagining modality. Non-limiting examples of imaging modality or medical device may be ultrasound imaging device, CT, magnetic resonance imaging (MRI), functional MRI (e.g., fMRI, DCE-MRI, and diffusion MRI), cone beam computed tomography (CBCT), Spiral CT, positron emission tomography (PET), single photon emission computed tomography (SPECT), Xray, optical tomography, fluorescence imaging, ultrasound imaging, radiotherapy portal imaging and so forth. Further, the control components may be foot switch, gantry remote control, other switches and controllers and so forth. Furthermore, simulation model may be an analytical model in machine-executable form derived from a data-driven model associated with a medical device. The simulation model may be a 1-dimensional (1D) model, a 2-dimensional (2D) model, a 3-dimensional (3D) model or a combination thereof. The simulation instance may be executed in the simulation environment as one of stochastic simulations, deterministic simulations, dynamic simulations, continuous simulations, discrete simulations, local simulations, distributed simulations, co-simulations or a combination thereof. It must be understood that the simulation models referred to in the present disclosure may include both system-level models and component-level models associated with the medical device.

At act 304, the simulation model of the medical device is hosted on the server 110. In an embodiment, the simulation model of the medical device and the at least one control component may be hosted in the first server 110A and the second server 110B respectively on a private network, thereby ensuring security of the simulation model of the medical device. The method of hosting the simulation model further includes sorting the received simulation data into different modules. In an example, for a CT simulator, the received simulation data is segregated into different modules such as CT simulator primary module (including console), foot switch, gantry remote control and so forth. In an exemplary implementation, the different modules of the CT simulator are hosted on different servers in a protected zone.

At act 306, the simulation model is securely provided on the at least one first graphical user interface 114A and the at least one second graphical user interface 114B. Herein, the first graphical user interface 114A corresponds to a trainer and the second graphical user 114B interface corresponds to a trainee. In an embodiment, the simulation model is securely provided on the at least one first graphical user interface 114A and the at least one second graphical user interface 114B via the third server. Optionally, the third server is configured to establish a secure connection between the first server 110A, the second server 110B and user devices associated with the first graphical user interface 114A and the at least one second graphical user interface 114B. In an example, the third server is a Guacamole server. The third server converts the converts the data stream received from the simulator hosted in a VNC server and converts it to Guacamole protocol which can be relayed over the internet (HTTPS). The third server creates an endpoint URL for every VNC server such that each unit of the simulator is represented with endpoints created by Guacamole. The third server enables the management of endpoints with the help of a backend component. Hereinafter, for the sake of simplicity and clarity the third server may sometimes be also referred to as the Guacamole server. In an embodiment, the third server further includes validating an authenticity of the user devices associated with the first graphical user interface 114A and the at least one second graphical user interface 114B using the database 108 including valid user devices.

According to an embodiment, a change in the simulation model is recorded from a first state to a second state on a first graphical user interface 114A based on an input on the first graphical user interface 114A. The first state corresponds to a functional state of the simulator at a particular instance of time. The second state corresponds to a next functional state of the simulator based on the input fed to the simulator. In other words, second state is the functional output of the simulator when an input is fed to the simulator using the first graphical interface. In an example, the medical device is a CT simulator, and control components may be a foot switch and a gantry remote control. The input may be switching the footswitch “ON” from “OFF”. The first state of the CT simulator is when the radiation is zero i.e. off state of the simulator, and the second state is when the radiation is up to a predefined level. The change in the CT simulator is recorded by the processing unit 104. In a preferred embodiment, the trainer provides input to the footswitch and change in radiation levels is recorded. Further, the change in the simulation model from the first state to the second state is outputted on the at least one second graphical user interface 114B in realtime. Furthermore, the change in the state of the CT simulator is provided to each of the second graphical user interface 114B each associated with a user device pertaining to the trainees in real-time.

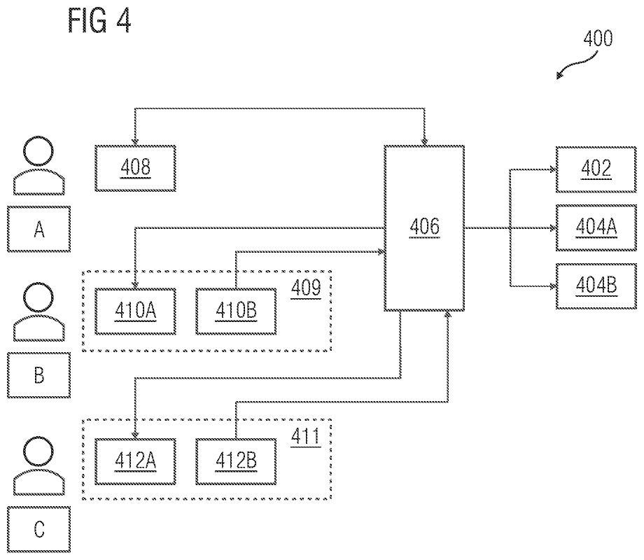

According to an embodiment, the at least one control component is activated on the at least one second graphical user interface 114B associated with the trainee based on a response from the trainer on the first graphical user interface. In an example, when a training session is in progress, the trainer may choose to provide access to any of the trainees. This may be done by providing a corresponding input on the first graphical user interface 114A associated with the user device pertaining to the trainer. In an embodiment, activating the at least one control component on the at least one second graphical user interface 114B further includes providing viewing access to the at least one second graphical user interface 114B. In such a case, the trainee would be allowed to only view the operations being performed on the control component by the trainer. In another embodiment, activating the at least one control component on the at least one second graphical user interface 114B further includes providing control access to the at least one second graphical user interface 114B. In such a case, the trainee would be allowed to input controls to change the operation of the control component. For the sake of understanding and clarity such operations are explained in greater detail in FIGS. 4, 5 and 6.

Referring to FIG. 4, a flow diagram 400 depicting interaction between user devices and simulator is illustrated, in accordance with an embodiment. As shown, the simulation model of the medical device 402 and at least one control components 404A and 404B are hosted on different servers. In particular, the medical device is a CT simulator 402, and control components are gantry remote control 404A and footswitch 404B. The CT simulator 402, and control components are gantry remote control 404A and footswitch 404B are provided to the user devices 407, 409 and 411 associated with users A, B and C respectively via the third server 406. In an example, the user A is a trainer, and the user B is a trainee and user C is another trainer. The users A, B, C are enabled to access the CT simulator 402, and control components are gantry remote control 404A and footswitch 404B through a training portal installed in the respective user devices 407, 409 and 411. In an example, the trainer A creates a training session via the training portal and invites trainee B and trainee C to the training session. The trainer A demonstrates the functioning of the CT simulator 402 by providing inputs on the graphical user interface 408. The change in state of the CT simulator 402 is provided to the trainee B and trainee C in real-time. The trainee B is enabled to observe the change in state of the CT simulator 402 on a browser tab 410A of the graphical user interface associated with the user device 409. The trainee C is enabled to observe the change in state of the CT simulator 402 on a browser tab 412A of the graphical user interface associated with the user device 411. Furthermore, the change in operations of the control components 404A and 404B are provided to the trainee B and trainee C in real-time on browser tab 410B of the graphical user interface associated with the user device 409 and bowser tab 412B of the graphical user interface associated with the user device 411 respectively.

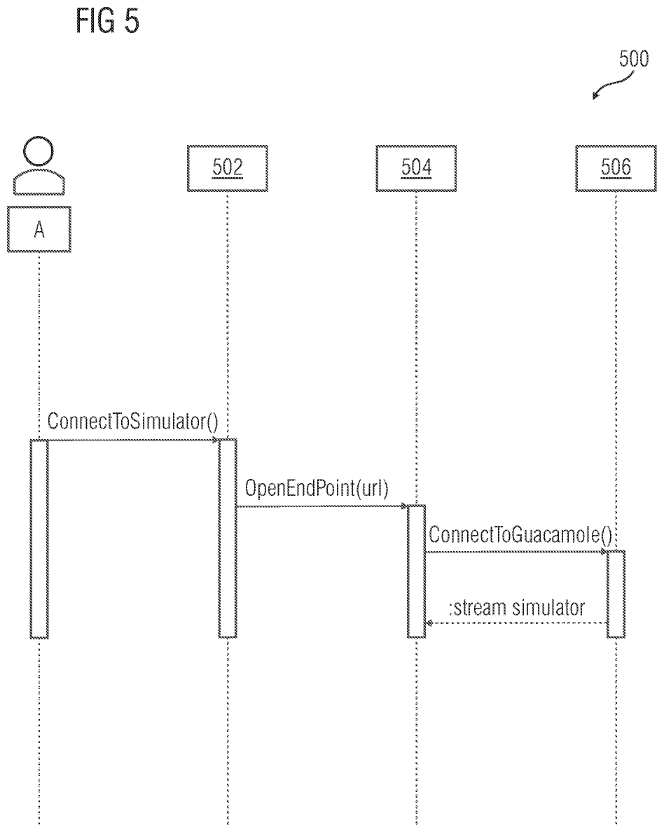

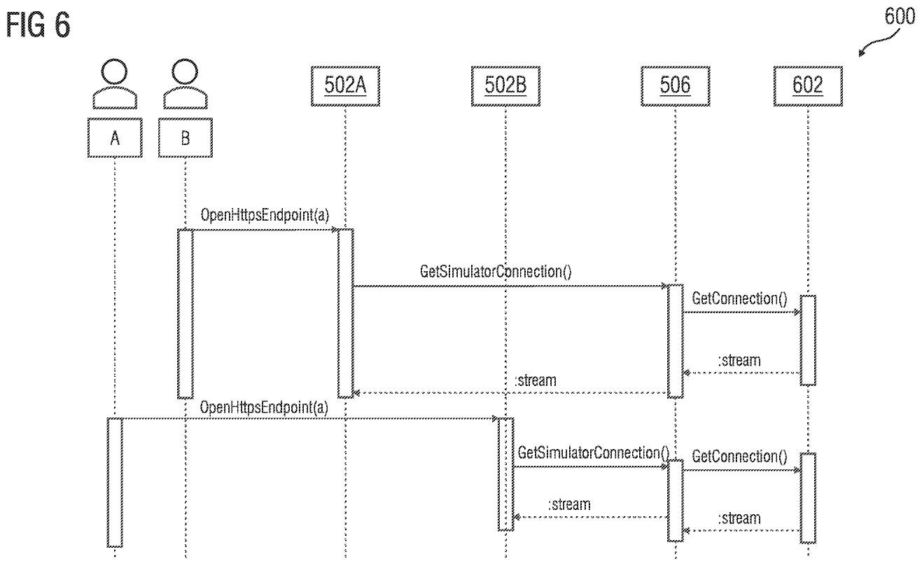

Referring to FIG. 5, a control flow diagram 500 depicting exchange of control signals between one or more entities of the system 100 is illustrated, in accordance with an embodiment. The exchange of control signals between various entities such as training portal 502, browser tab 504 and guacamole server 506 is depicted in the control flow diagram 500. In an exemplary implementation, a training session is created by the user or trainer ‘A,’ and multiple trainees are invited to the training session. The trainer A provides access to the simulator by sharing scanner console with each of the trainees and activating endpoints in the first graphical user interface. Further, each of the trainees are prompted to click on the “connect” button enabled for the simulator components on the second graphical user interfaces associated with the trainees respectively. An input provided on the “connect” button by the trainee directs the trainee to a new browser tab and connects to the allocated endpoint (herein, scanner console of the CT simulator). Based on the response on the second graphical interface of the training portal 502, a connection is established between the browser tab 504 and the Guacamole server 506. The browser 504 acts like a client and maintains a continuous connection with the server 506 to receive image stream of the CT simulator running in the protected network such as the first server 110A. Each of the trainees get viewing access to the endpoint controlled by the trainer. The same instance of the CT simulator is shared with all the trainees in real-time. Exchange of control signals for multiple user access is described in detail in FIG. 6.

Referring to FIG. 6, a control flow diagram 600 depicting exchange of control signals between one or more entities of the system 100 is illustrated, in accordance with another embodiment. The exchange of control signals between various entities such as training portal 502A pertaining to the trainer A and training portal 502B pertaining to the trainee B, guacamole server 506, and simulator 602 is depicted in the control flow diagram 600. The trainer A creates a training session and invites trainee B to the session. The trainer A is enabled to access the simulator 602 via training portal 502A and the trainee B is enabled to access the simulator 602 via the training portal 502B. The guacamole server 506 is configured to provide access to the users A and B at the same time. The control flow diagram 600 depicts multiple user access to the simulator 602 via the guacamole server 506. As shown, trainer ‘A’ provides an input to ‘OpenHttpsEndpoint( )’ to initiate a request to access the simulator 602 using the endpoints exposed to the trainer A. The request ‘OpenHttpsEndpoint( )’ is acknowledged by the browser in the training portal 502A and a request ‘GetSimulatorConnection( )’ is sent to the guacamole server 506. The guacamole server 506 forwards the request to the simulator 602 for providing access to the trainer A. In response, the simulator 602 provides access to the guacamole server 602 and datastream of the functioning of the simulator is shared with the guacamole server 506. The guacamole server 506 converts the simulator datastream to a guacamole protocol which can be relayed over the internet (HTTPS). The guacamole server 506 creates an endpoint URL for console of the simulator 602. Notably, each server pertaining to each component of the simulator 602 is represented with an endpoint URL on the respective graphical user interfaces. Further, the guacamole server 506 relays the data stream of the simulator 602 to the graphical user interface 502A over the internet.

Similarly, trainer ‘A’ provides an input to ‘OpenHttpsEndpoint( )’ to initiate a request to access the simulator 602 using the endpoints exposed to the trainer A. The request ‘OpenHttpsEndpoint( )’ is acknowledged by the browser in the training portal 502A and a request ‘GetSimulatorConnection( )’ is sent to the guacamole server 506. The guacamole server 506 forwards the request to the simulator 602 for providing access to the trainer ‘A’. In response, the simulator 602 provides access to the guacamole server 602 and datastream of the functioning of the simulator is shared with the guacamole server 506. The guacamole server 506 converts the simulator datastream to a guacamole protocol, which can be relayed over the internet (HTTPS). The guacamole server 506 creates an endpoint URL for console of the simulator 602. Notably, each server pertaining to each component of the simulator 602 is represented with an endpoint URL on the respective graphical user interfaces. Further, the guacamole server 506 is configured to relay the datastream of the simulator 602 to the graphical user interface 502A over the internet.

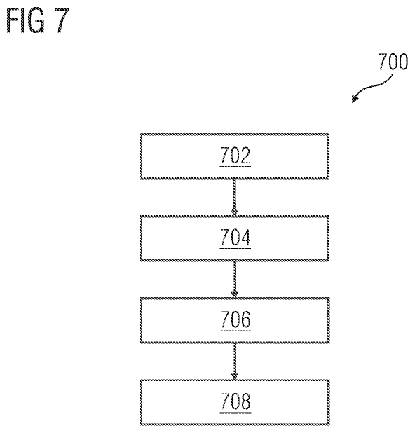

Referring to FIG. 7, a flowchart 700 depicting acts of a method for providing viewing access to the at least one second graphical user interface 114B, in accordance with an embodiment. At act 702, a change in an operation of the control component from a first parameter to a second parameter is recorded based on an input on the first graphical user interface 114A. At act 704, the change in the operation of the control component from the first parameter to the second parameter is outputted on the at least one second graphical user interface 114B in real-time. At act 706, a change in the simulation model is recorded based on the change in the operation of the control component. At act 708, the change in the simulation model is outputted on the at least one second graphical user interface 114B in realtime.

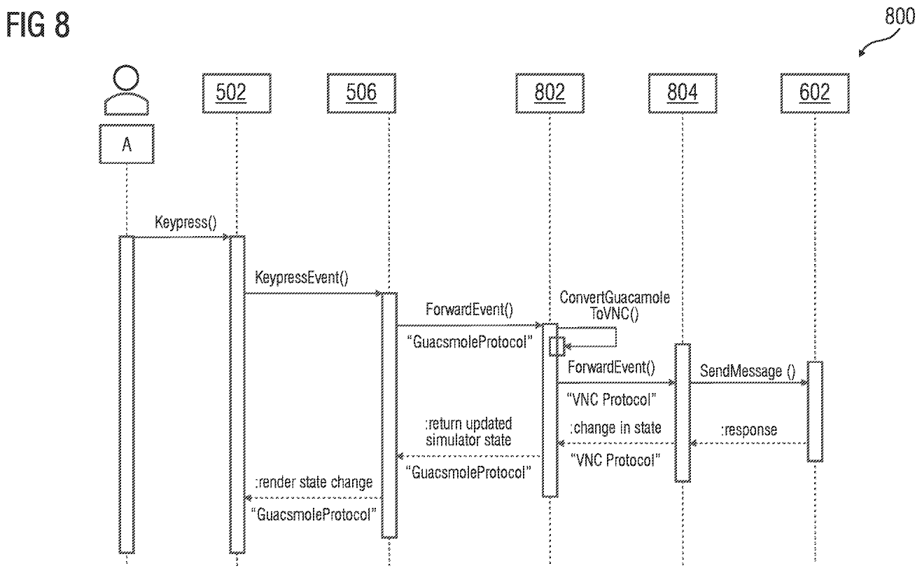

Referring to FIG. 8 a control flow diagram 800 depicting exchange of control signals between one or more entities for providing viewing access to the at least one second graphical user interface is illustrated, in accordance with an embodiment. The exchange of control signals between the training portal 502, guacamole server 506, guacamole client 802, client server 804 and simulator 602 is depicted in the control flow diagram 800. The training portal 502 is associated with the user A. In an example, the user A is a trainer associated with the training portal 502. While a training session is in progress, the trainer A provides an input to the training portal 502. In an example, an input is provided to the control component on the training portal 502 to record a change in an operation of the control component from a first parameter to a second parameter. As show, a “keypress( )” input is received on the training portal 502. The “keypress( )” input is acknowledged by the training portal 502 and is forwarded to the guacamole server 506. The guacamole server 506 initiates a “ForwardEvent( )” to the guacamole client 802. The guacamole client 802 initiates the guacamole protocol and converts the “keypress( )” event from the guacamole protocol to a VNC protocol via function “ConvertGuacamoleToVNC( )”. Further, the guacamole client 802 forwards the converted input to the VNC client 804 using function “ForwardEvent( )”. The VNC client 804 receives the forwarded input and sends a message to the simulator 602 using function “SendMessage( )”. The simulator 602 acknowledges the input on the training portal 502 and provides a response by changing the state of the simulator 602 from a first state to the second state. The response or the change in state is received by the VNC client 804 and is forwarded to the guacamole client 802 using the VNC protocol. The guacamole client 802 converts the converts the updated simulator state back to the guacamole protocol from the VNC protocol. Further, the guacamole client 802 returns the updated simulator state to the guacamole server 506 using the guacamole protocol. The guacamole server 506 renders the update simulator state on the training portal 502.

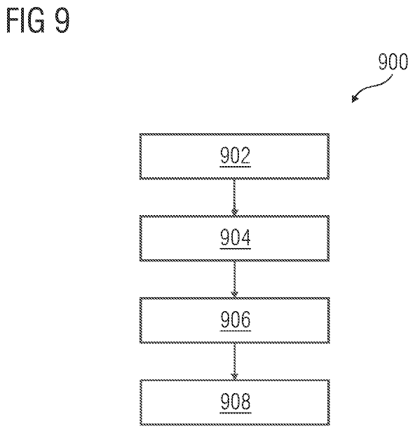

Referring to FIG. 9, a flowchart depicting acts of a method 900 for providing control access to the at least one second graphical user interface 114B is illustrated, in accordance with an embodiment. At act 902, a change in an operation of the control component from a first parameter to a second parameter is recorded based on an input on the at least one second graphical user interface 114B. At act 904, the change in the operation of the control component from the first parameter to the second parameter is output on the first graphical user interface 114A and the at least one second graphical user interface 114B in real-time. At act 906, a change in the simulation model is recorded based on the change in the operation of the control component. At act 908, the change in the simulation model is output on the first graphical user interface 114A and at least one second graphical user interface 114B in real-time.

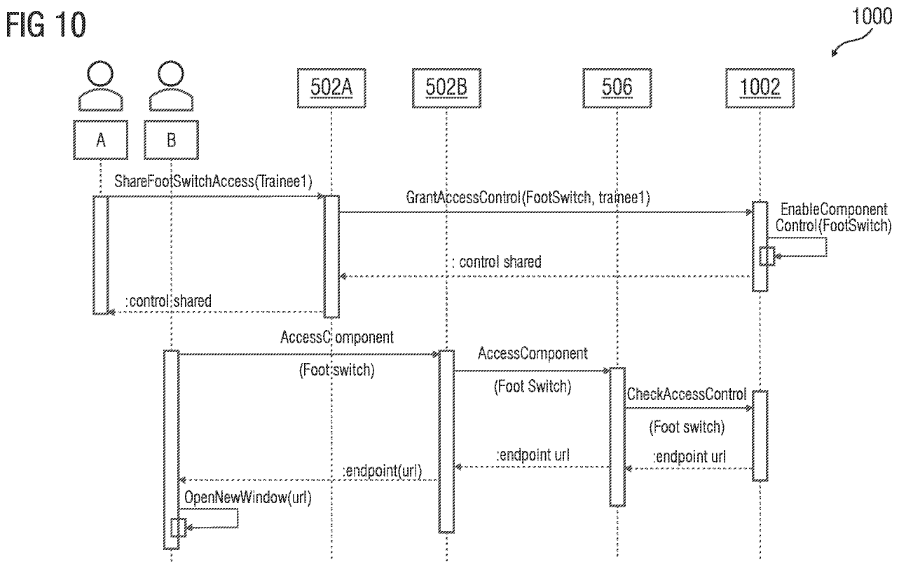

Referring to FIG. 10, a control flow diagram 1000 depicting exchange of control signals between one or more entities for providing control access to the at least one second graphical user interface is illustrated, in accordance with an embodiment. The exchange of control signals between the training portal 502A and 502B, guacamole server 506, and backend server 1002 is depicted in the control flow diagram 800. The training portal 502A is associated with the user A and the training portal 502B is associated with the user B. In an example, the user A is a trainer, and the user B is a trainee. While a training session is in progress, and control access is to be provided to a particular trainee, the trainer A shares control to the trainee B by requesting access on the training portal 502A. In an example, for providing control access of a foot switch in a CT simulator, a request “ShareFootSwitchAccess(TraineeB)” is received on the training portal 502A. The training portal 502A raises a request “GrantAccessControl(FootSwitch,TraineeB)” to the backend server 1002. The backend server 1002 validates the authenticity of the trainee B by validating the credential of the trainee B using the database 108. The backend server 1002 validates the credentials of the trainee B and grants access to the trainee B if the credentials are successfully validated. A function “EnableComponentControl(FootSwitch)” is generated by the backend server 1002 post validation. Subsequently, the backend server 1002 shares the control to the trainee B on the training portal 502B. When the control access is received by the trainee B, the trainee B access the control component using the training portal 502B. The access component is forwarded to the guacamole server 506 to convert the control access of the foot switch to the VNC protocol. Further, the guacamole server 506 forwards the access control to the backend server 1002 to check the access control of the foot switch. The backend server 1002 activates an endpoint URL for the foot switch and provides the same to the trainee B to allow control access to the foot switch component. Subsequently, a new browser tab is opened on the training portal 502B to provide access to the trainee B.

The present invention may take the form of a computer program product including program modules accessible from non-transitory computer-usable or computer-readable medium storing program code for use by or in connection with one or more computers, processors, or instruction execution system. For the purpose of this description, a computer-usable or computer-readable medium is any apparatus that may contain, store, communicate, propagate, or transport the program for use by or in connection with the instruction execution system, apparatus, or device. The medium may be electronic, magnetic, optical, electromagnetic, infrared, or semiconductor system (or apparatus or device). Propagation mediums in and of themselves as signal carriers are not included in the definition of physical computer-readable medium, which may include a semiconductor or solid state memory, magnetic tape, a removable computer diskette, random access memory (RAM), a read only memory (ROM), a rigid magnetic disk and optical disk such as compact disk read-only memory (CDROM), compact disk read/write, and DVD. Both processors and program code for implementing each aspect of the technology may be centralized or distributed (or a combination thereof) as known to those skilled in the art.

The present embodiments aim at providing a system and a method to enhance multiuser interaction during a virtual training session. A method is provided for sharing individual simulator unit and control components with multiple users simultaneously, thereby providing seamless experience to users in accessing the simulation model in real-time. Furthermore, the simulation model is securely provided to multiple users by securing the simulation model in a protected zone and providing it to end-user with the help of the third server. A method is provided for securing the simulation model, thereby preventing any malicious activity from an attacker. Moreover, multiple user access to the simulation model is enabled using a web browser. Advantageously, the simulation model and its components are hosted in secure independent private networks and shared through the third server, therefore allowing multiples sessions to be created and shared with multiple users through dedicated endpoints. Furthermore, a realistic and hand-on experience is provided to trainees engaged in a virtual training session by enabling real-time access to the simulation model to multiple trainees. Beneficially, both the trainer and the trainee have access to the same simulation model, thereby enabling the trainer to guide the trainee more efficiently to perform operations on the simulation model. Moreover, a way to provide training remotely is provided. The way saves cost on travel and loss of additional working days required to travel to training center in case of offline trainings, thereby making the system and method time efficient and cost efficient.

While the invention has been illustrated and described in detail with the help of a preferred embodiment, the invention is not limited to the disclosed examples. Other variations can be deduced by those skilled in the art without leaving the scope of protection of the claimed invention.

What is claimed is:

1. A method for providing interactive virtual training to multiple medical personnel in realtime, the method comprising:
receiving, by a processing unit, simulation data pertaining to a medical device;
hosting a simulation model of the medical device on a server, wherein the simulation model is generated from the received simulation data; and
securely providing the simulation model on at least one first graphical user interface and at least one second graphical user interface, wherein the at least one first graphical user interface corresponds to a trainer and the at least one second graphical user interface corresponds to a trainee.

2. The method according to claim 1, wherein the server comprises a first server and at least one second server hosted in private networks.

3. The method according to claim 2, wherein the simulation model comprises a simulator and at least one control component, and wherein the simulator is hosted on the first server and the at least one control component is hosted on the at least one second server

4. The method according to claim 1, wherein providing the simulation model on the at least one first graphical user interface and on the at least one second graphical user interface comprises:
recording a change in the simulation model from a first state to a second state on the at least one first graphical user interface based on an input on the at least one first graphical user interface; and
outputting the change in the simulation model from the first state to the second state on the at least one second graphical user interface in real-time.

5. The method according to claim 1, wherein providing the simulation model on the at least one first graphical user interface and on the at least one second graphical user interface comprises:
activating the at least one control component on the at least one second graphical user interface associated with the trainee based on a response from the trainer on the at least one first graphical user interface.

6. The method according to claim 5, wherein activating the at least one control component on the at least one second graphical user interface further comprises providing viewing access to the at least one second graphical user interface.

7. The method according to claim 6, wherein providing viewing access to the at least one second graphical user interface comprises:
recording a change in an operation of the control component from a first parameter to a second parameter based on an input on the at least one first graphical user interface;
outputting the change in the operation of the control component from the first parameter to the second parameter on the at least one second graphical user interface in real-time;
recording a change in the simulator based on the change in the operation of the control component; and
outputting the change in the simulator on the at least one second graphical user interface in real-time.

8. The method according to the claim 5, wherein activating the at least one control component on the at least one second graphical user interface further comprises providing control access to the at least one second graphical user interface.

9. The method according to claim 8, wherein providing control access to the at least one second graphical user interface comprises:
recording a change in an operation of the control component from a first parameter to a second parameter based on an input on the at least one second graphical user interface;
outputting the change in the operation of the control component from the first parameter to the second parameter on the at least one first graphical user interface and the at least one second graphical user interface in real-time;
recording a change in the simulation model based on the change in the operation of the control component; and
outputting the change in the simulator on the at least one first graphical user interface and the at least one second graphical user interface in real-time.

10. The method according to claim 1, wherein securely providing the simulator on the at least one first graphical user interface and the at least one second graphical user interface further comprises:
establishing a secure connection between the first server, the second server and user devices associated with the first graphical user interface and the at least one second graphical user interface via a third server.

11. The method according to claim 10 further comprising validating an authenticity of the user devices associated with the at least one first graphical user interface and/or the at least one second graphical user interface using a database comprising valid user devices.

12. An apparatus for providing interactive virtual training to multiple medical personnel in real-time, the apparatus comprising:
at least one processor;
a database comprising information pertaining to valid user devices;
a memory communicatively coupled to the at least one processor, the memory comprising a simulator access module that when executed by the processor is configured to:
receive simulation data pertaining to a medical device;
host a simulation model of the medical device on a server, wherein the simulation model is generated from the received simulation data; and
securely provide the simulation model on at least one first graphical user interface and at least one second graphical user interface, wherein the at least one first graphical user interface corresponds to a trainer and the at least one second graphical user interface corresponds to a trainee.

13. The apparatus according to claim 12, wherein the simulator access module is configured to:
record a change in the simulation model from a first state to a second state on the at least one first graphical user interface based on an input on the at least one first graphical user interface; and
output the change in the simulation model from the first state to the second state on the at least one second graphical user interface in real-time.

14. The apparatus according to claim 12, wherein the simulator access module is configured to activate the at least one control component on the at least one second graphical user interface associated with the trainee based on a response from the trainer on the at least one first graphical user interface.

15. The apparatus according to claim 14, wherein the simulator access module is further configured to provide viewing access to the at least one second graphical user interface.

16. The apparatus according to claim 15, wherein the simulator access module is configured to:
record a change in an operation of the control component from a first parameter to a second parameter based on an input on the at least one first graphical user interface;
output the change in the operation of the control component from the first parameter to the second parameter on the at least one second graphical user interface in real-time;
record a change in the simulator based on the change in the operation of the control component; and
output the change in the simulator on the at least one second graphical user interface in real-time.

17. The apparatus according to the claim 14, wherein the simulator access module is configured to provide control access to the at least one second graphical user interface.

18. The apparatus according to claim 17, wherein the simulator access module is configured to:
record a change in an operation of the control component from a first parameter to a second parameter based on an input on the at least one second graphical user interface;
output the change in the operation of the control component from the first parameter to the second parameter on the at least one first graphical user interface and the at least one second graphical user interface in real-time;
record a change in the simulation model based on the change in the operation of the control component; and
output the change in the simulator on the at least one first graphical user interface and the at least one second graphical user interface in real-time.

19. A system for providing interactive virtual training to multiple medical personnel in realtime, the system comprising:
a server for remotely hosting a simulation model of the medical device; and
a cloud computing platform comprising computer readable instructions, which when executed by a processor cause the processor to:
receive simulation data pertaining to a medical device;
host a simulation model of the medical device on a server, wherein the simulation model is generated from the received simulation data; and
securely provide the simulation model on at least one first graphical user interface and at least one second graphical user interface, wherein the at least one first graphical user interface corresponds to a trainer and the at least one second graphical user interface corresponds to a trainee.

20. A non-transitory computer readable storage medium storing machine-readable instructions therein, that when executed by a processor, causes the processor to:
receive simulation data pertaining to a medical device;
host a simulation model of the medical device on a server, wherein the simulation model is generated from the received simulation data; and
securely provide the simulation model on at least one first graphical user interface and at least one second graphical user interface, wherein the at least one first graphical user interface corresponds to a trainer and the at least one second graphical user interface corresponds to a trainee.
